(19) United States
(12) Patent Application Publication
(10) Pub. No.: US 2025/0251548 A1
(43) Pub. Date: Aug. 7, 2025

(54) OPTICAL SWITCH ASSEMBLY

(71) Applicant: Mellanox Technologies, Ltd., Yokneam (IL)

(72) Inventors: Ran Hasson Ruso, Tel Aviv (IL); Dimitrios Kalavrouziotis, Papagou (GR); Elad Mentovich, Tel Aviv (IL); Paraskevas Bakopoulos, Ilion (GR); Ioannis (Giannis) Patronas, Piraeus (GR)

(73) Assignee: Mellanox Technologies, Ltd., Yokneam (IL)

(21) Appl. No.: 18/432,531

(22) Filed: Feb. 5, 2024

(30) Foreign Application Priority Data
Feb. 1, 2024 (GR) 20240100068

(51) Int. Cl. G02B 6/35

(52) U.S. Cl. CPC G02B 6/3504; G02B 6/3546

(57) ABSTRACT

Assemblies and methods are provided for optical switch assemblies. An example optical switch assembly includes a first switch member configured to support a first plurality of optical fibers. The first switch member is designed to selectively rotate about a first longitudinal axis. The assembly further includes a second switch member configured to support a second plurality of optical fibers. The second switch member defines a second longitudinal axis aligned with the first longitudinal axis. In a first position of the first switch member, a first subset of the first plurality of optical fibers is aligned with a first subset of the second plurality of optical fibers for transmitting optical signals therebetween. In a second position of the first switch member, a second subset of the first plurality of optical fibers is aligned with a second subset of the second plurality of optical fibers for transmitting optical signals therebetween.

### CROSS-REFERENCE TO RELATED APPLICATIONS

This application claims priority to Greek patent application No. 20240100068, filed Feb. 1, 2024, the entire contents of which application are hereby incorporated herein by reference.

### TECHNOLOGICAL FIELD

Example embodiments of the present disclosure relate generally to topology for mechanically-controlled optical switches.

### BACKGROUND

The rapid growth and increasing complexity of data centers has encouraged the cointegration of photonics and electronics in multi-chip modules. Optical switching as a technology has played an increasingly greater role in the function and management of photonics within datacenters, and efficient optical switching topology may become increasingly valuable as datacenters continue to advance in scale and intricacy. Applicant has identified numerous deficiencies and problems associated with conventional optical switching topology. Through applied effort, ingenuity, and innovation, many of these identified problems have been solved by developing solutions that are included in embodiments of the present disclosure, many examples of which are described in detail herein.

### BRIEF SUMMARY

Embodiments of the present disclosure are directed to an optical switch assembly and associated methods of manufacturing optical switch assemblies. In some embodiments, the optical switch assembly may include a first switch member configured to support a first plurality of optical fibers and the first switch member may define a first longitudinal axis. The optical switch assembly may further include a second switch member configured to support a second plurality of optical fibers. The second switch member may define a second longitudinal axis, and the second longitudinal axis may be aligned with the first longitudinal axis. The first switch member may be configured to selectively rotate about the first longitudinal axis. At a first position of the first switch member, a first subset of the first plurality of optical fibers may be aligned with a first subset of the second plurality of optical fibers for transmitting optical signals therebetween. The first switch member may be configured to rotate to a second position. At the second position of the first switch member, a second subset of the first plurality of optical fibers may be aligned with a second subset of the second plurality of optical fibers for transmitting optical signals therebetween.

In some embodiments, the first subset of the first plurality of optical fibers may be the same as the second subset of the first plurality of optical fibers.

In some embodiments, the first subset of the second plurality of optical fibers may be the same as the second subset of the second plurality of optical fibers.

In some embodiments, each of the first switch member and the second switch member comprises a cylindrical fiber assembly defining a plurality of grooves configured to receive optical fibers therein.

In some embodiments, the second switch member may be fixed about the second longitudinal axis.

In some embodiments, the first switch member comprises N inputs and the second switch member comprises M outputs. The optical switch assembly may be configured to provide N×M input-output permutations.

In some embodiments, N may be equal to M.

In some embodiments, the optical switch assembly further includes an actuator coupled to the first switch member. The actuator may be configured to selectively rotate the first switch member about the first longitudinal axis.

In some embodiments, the first switch member may be configured to rotate about the first longitudinal axis based at least in part on a triggering event.

In some embodiments, the first plurality of optical fibers and the second plurality of optical fibers include lensed optical fibers.

In some embodiments, at least one of the first switch member or the second switch member may include at least one lens configured to direct the optical signal between an optical fiber of the first switch member and a corresponding optical fiber of the second switch member.

In some embodiments, the second switch member may be configured to selectively rotate about the second longitudinal axis.

A method of manufacturing an optical switch assembly is also provided according to some embodiments. The method may include providing a first switch member configured to support a first plurality of optical fibers. The first switch member may define a first longitudinal axis. The method may further include providing a second switch member configured to support a second plurality of optical fibers. The second switch member may define a second longitudinal axis. The method may further include coupling the first switch member relative to the second switch member such that the second longitudinal axis is aligned with the first longitudinal axis and transmission of optical signals between the first switch member and the second switch member is enabled. The first switch member may be configured to selectively rotate about the first longitudinal axis. In a first position of the first switch member, a first subset of the first plurality of optical fibers may be aligned with a first subset of the second plurality of optical fibers for transmitting the optical signals therebetween. The first switch member may be configured to rotate to a second position. In the second position of the first switch member, a second subset of the first plurality of optical fibers may be aligned with a second subset of the second plurality of optical fibers for transmitting the optical signal therebetween.

In some embodiments, providing each of the first switch member and the second switch member includes providing a cylindrical fiber assembly and defining a plurality of grooves configured to receive the first and second optical fibers respectively therein.

In some embodiments, the second switch member may be fixed about the second longitudinal axis.

In some embodiments, the first switch member includes N inputs, and the second switch member includes M outputs. The optical switch assembly may be configured to provide N×M input-output permutations.

In some embodiments, the first plurality of optical fibers and the second plurality of optical fibers include lensed optical fibers.

In some embodiments, at least one of the first switch member or the second switch member includes at least one lens configured to direct optical signals between an optical fiber of the first switch member and a corresponding optical fiber of the second switch member.

In some embodiments, the method further includes coupling an actuator to the first switch member. The actuator may be configured to rotate the first switch member about the first longitudinal axis.

In some embodiments, the first switch member may be configured to rotate about the first longitudinal axis based at least in part on a triggering event.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1A is a schematic perspective view of a switch member of an optical assembly in accordance with some embodiments described herein;

FIG. 1B is a schematic cross-sectional view of the switch member of FIG. 1A in a first position in accordance with some embodiments described herein;

FIG. 1C is a schematic cross-sectional view of the switch member of FIG. 1A in a second position in accordance with some embodiments described herein;

FIG. 2 is a schematic perspective view of an optical switch assembly comprising a first switch member and a second switch member in accordance with some embodiments described herein;

FIG. 3 is a flowchart illustrating a method of manufacturing an optical switch assembly according to some embodiments described herein; and

FIG. 4 is a schematic block diagram of a first switch member coupled to an actuator according to some embodiments described herein.

### DETAILED DESCRIPTION

Embodiments of the present disclosure now will be described more fully hereinafter with reference to the accompanying drawings in which some but not all embodiments are shown. Indeed, the present disclosure may be embodied in many different forms and should not be construed as limited to the embodiments set forth herein; rather, these embodiments are provided so that this disclosure will satisfy applicable legal requirements. Like numbers refer to like elements throughout. As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

An optical fiber is a flexible, transparent fiber made by drawing glass or plastic to a compressed diameter. Optical fibers may be used for telecommunications, long distance transmissions, power transmissions, light transmissions, sensor applications, and computer networking. An optical fiber may include a core surrounded by a cladding material with a lower index of refraction. In some cases, an optical fiber may include a cylindrical dielectric waveguide that transmits light along its axis through a process of total internal reflection. Materials used in the creation of optical fibers may include silica, fluorozirconate (fluoride glass), fluoroaluminate, chalcogenide glasses, crystalline materials, and/or a combination of such materials.

An optical switch as described herein has at least one optical input and a plurality of optical output ports. An optical signal traveling through the optical switch may be routed from the input port to a selected one of the optical output ports within the optical switch, thereby allowing the optical signal from a particular source to be delivered to one of a number of possible destinations. In some cases, the optical switch may be triggered (e.g., an optical output port may be selected) by an event, signal, measurement, and/or crossed limit within an optical, electrical, mechanical, microelectromechanical, and/or electro-optical domain that causes a change in the input-output configuration. Types of optical switches as described herein may include micro-electromechanical system (MEMS) switches, piezo switches, and electromechanical switches. Such switches may rely on active and passive fiber optic components to initiate a change of the input-output configuration of the optical switch.

Optical engagement between optical fibers supported by an optical switch may be utilized across multiple fields and industries involving technologies associated with optical communication, optical sensors, datacenters, and quantum computing. Optical switches May support one or more optical fibers and may be configured to direct an optical signal (e.g., light) from an optical fiber (e.g., at an input end) into a corresponding optical fiber of an optical component (e.g., at an output end) to enable communication between the optical fibers. The connection between optical fibers via the switch may be accomplished after alignment of the one or more input optical fibers with the one or more output optical fibers, as will be understood by one skilled in the art in light of this disclosure.

Expanding datacenters have relied upon increasingly complex circuitry and photonics to accommodate growing demand for online activities and computing capabilities. In such environments, routing of optical signals through optical switches such as electromechanical switches may be impractical due to size constraints and limited configuration options. For instance, electromechanical switches may be limited to a 1×N configuration (1 input with N outputs) or a 2×N configuration due to the mechanical nature of the switch and size constraints of the environment in which the optical switch is placed. Increasing the number of optical ports while accommodating space limitations and minimizing complexity for routing optical signals would provide greater versatility in datacenters and facilitate co-integration of electronics and photonics in multi-chip modules.

In order to address these issues and others, embodiments of the present invention are directed to an optical switch assembly. Although the embodiments described below may refer to optical switches in the form of electromechanical switches, one skilled in the art in light of this disclosure would understand that embodiments of the assembly and methods described herein could be applied to multiple types of optical switches. As described in greater detail below, embodiments of the assembly may comprise a plurality of input-output permutations within an optical switch. In particular, the embodiments described herein after may improve optical switch capabilities and versatility, while accommodating the spatial limitations associated with mechanically controlled optical switches. Furthermore, the embodiments described herein may rely on electromechanical switches and passive fiber-optic components to operate with minimized power loss.

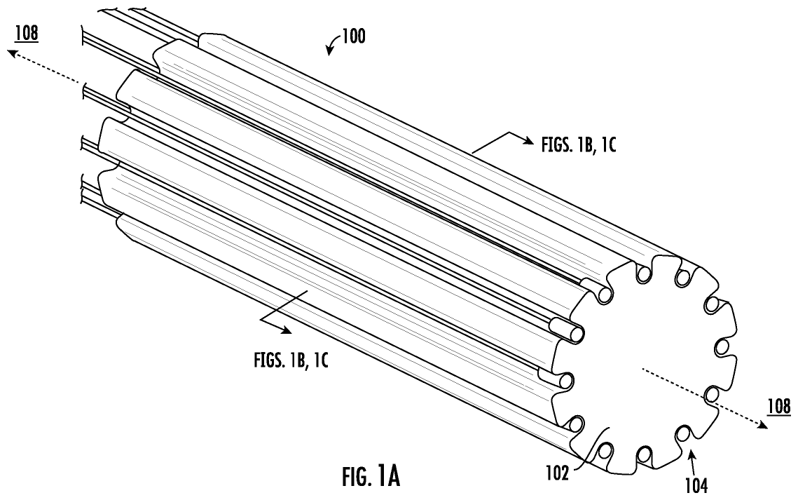

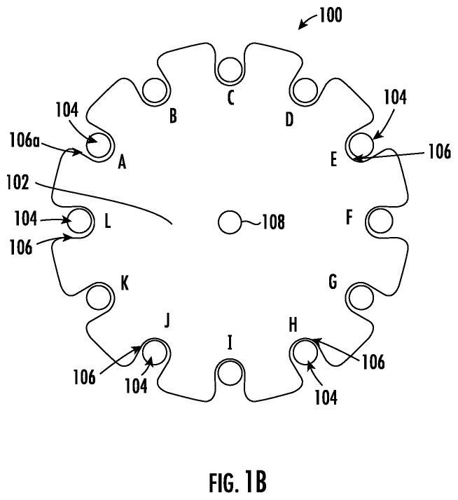

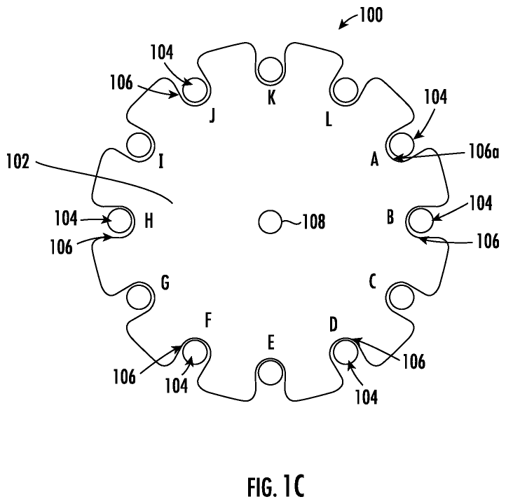

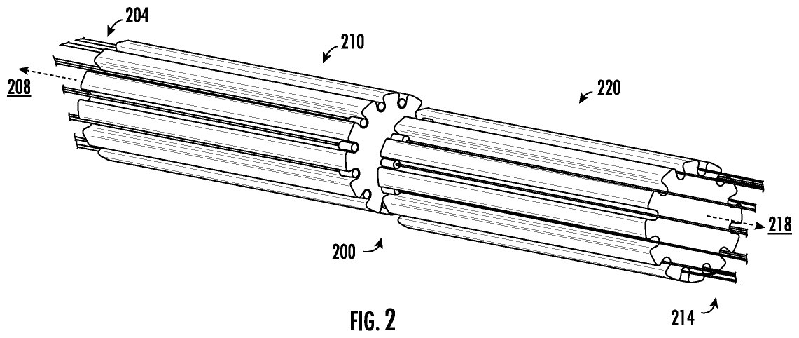

Accordingly, an optical switch assembly is described for aligning input optical fibers with output optical fibers facilitating more efficient and compact switching therebetween. As shown in FIG. 2, the optical switch assembly 200 may include a first switch member 210 and a second switch member 220. One or both of the first switch member 210 and the second switch member 220 may be configured as the switch member 100 shown in FIG. 1A and described below. One of the two switch members (the first switch member 210 and the second switch member 220) of the optical switch assembly 200 may comprise inputs, and the other may comprise outputs. The first switch member 210 may be configured to support a first plurality of optical fibers 204, and the first switch member may define a first longitudinal axis 208 (e.g., similar to the longitudinal axis 108 of the switch member 100 shown in FIG. 1A). Similarly, the second switch member 220 may be configured to support a second plurality of optical fibers 214, and the second switch member may define a second longitudinal axis 218 (e.g., similar to the longitudinal axis 108 of the switch member 100 shown in FIG. 1).

With continued reference to FIG. 2, the first switch member 210 may be configured to selectively rotate about the first longitudinal axis 208 such that, in a first position (an example of which is illustrated in FIG. 1B) of the first switch member, a first subset of the first plurality of optical fibers 204 is aligned with a first subset of the second plurality of optical fibers 214 for transmitting optical signals therebetween. The first switch member 210 may be further configured to rotate to a second position (an example of which is illustrated in FIG. 1C). In the second position of the first switch member 210, a second subset of the first plurality of optical fibers 204 may be aligned with a second subset of the second plurality of optical fibers 214 for transmitting optical signals therebetween. In this way, through rotation of the first switch member 210 in this example, the fiber alignments (first plurality of optical fibers 204 to second plurality of optical fibers 214) may be changed. As described in greater detail below, in some embodiments, the first subset of the first plurality of optical fibers may be the same as the second subset of the first plurality of optical fibers. In other words, in an example in which fibers A through L (shown in FIG. 1B) form the first subset and, in the second position (FIG. 1C), fibers A through L are still used to align with corresponding fibers of the second switch member, the first subset and the second subset of the first plurality of optical fibers are the same. If, however, in the second position, only fibers A-G are operably engaged with optical fibers of the second switch member, then the first subset (A-L) and the second subset (A-G) of the first plurality of optical fibers is not the same. Similarly, the first subset of the second plurality of optical fibers (e.g., the optical fibers received and supported by the second switch member 220) may be the same as the second subset of the second plurality of optical fibers in some embodiments, whereas in others they may be different.

With reference to FIG. 1A, a switch member 100, which may be the first switch member 210 or the second switch member 220 of FIG. 2, is described and illustrated according to some embodiments. As shown, the switch member 100 may comprise a cylindrical fiber assembly 102 that defines optical fiber grooves 106 and a longitudinal axis 108 The cylindrical fiber assembly 102 may be a cylindrical component, as shown, and the optical fiber grooves 106 may be configured to receive, support, store, hold, and/or contain a plurality of optical fibers 104 (which may be the first plurality of optical fibers 204 or the second plurality of optical fibers 214 described with respect to FIG. 2) therein. The optical fiber grooves 106 may be circumferentially arranged around the longitudinal axis 108 of the switch member 100, as shown, and may be spaced according to the total circumference of the cylindrical fiber assembly 102, the number of optical fiber grooves 106, the dimensions of the optical fiber grooves, and other structural and/or functional considerations.

In this regard, the optical fiber grooves 106 may be configured (e.g., sized and shaped) to have a width, depth, shape, etc. that accommodates the size and shape of an optical fiber to be received therein. For example, in some cases, the optical fiber grooves 106 may be configured (e.g., sized and shaped) to have a width, depth, shape, etc. for receiving and holding an optical fiber therein via a press fit. Additionally, in some cases, the optical fiber grooves 106 may be equally spaced around the total circumference of the cylindrical fiber assembly 102, as shown in FIGS. 1A-1C. In other cases (not shown), the optical fiber grooves 106 may be equally spaced around only a portion of the total circumference of the cylindrical fiber assembly 102, leaving another portion of the total circumference of the cylindrical fiber assembly devoid of optical fiber grooves. In still other cases (also not shown), the optical fiber grooves 106 may be unequally spaced around the total circumference of the cylindrical fiber assembly 102 or a portion of the total circumference. With reference to FIGS. 1A and 2, the optical fiber grooves of each switch member of the optical switch assembly may be configured to receive optical fibers therein. In some embodiments, the grooves 106 may further be configured to receive additional optical components, such as lenses, as described in greater detail below.

As noted above with respect to the first switch member 210, in some embodiments the switch member 100 may be configured to selectively rotate about the longitudinal axis 108, thereby changing a rotational position of the cylindrical fiber assembly 102 and, as a result, the rotational position of the plurality of optical fibers 104 received within the optical fiber grooves 106. For example, through rotation of the switch member 100, Fiber A received by an optical fiber groove 106a may be moved from the rotational position shown in FIG. 1B to the rotational position shown in FIG. 1C upon receipt of a triggering event. Selective rotation of the switch member 100 may be conducted by an actuator, as described in greater detail below.

With reference to FIG. 2, the first switch member 210 may be rotatable to achieve a number of rotational positions with respect to its longitudinal axis. In a first position, for example, the first plurality of optical fibers 204 of the first switch member 210 may be aligned with the second plurality of optical fibers 214 of the second switch member 220 to allow one or more of the first plurality of optical fibers 204 to optically engage with one or more of the second plurality of optical fibers 214. For instance, in some embodiments the first switch member 210 may be configured to receive twelve optical fibers 204, as shown. Similarly, the second switch member 220 may also be configured to receive twelve optical fibers 214, as shown. In this example, the first switch member 210 may be configured to selectively rotate into twelve discrete positions, thereby allowing each of the twelve optical fibers 204 to be aligned with a different one of the twelve optical fibers 214, facilitating connections therebetween. In other words, in one position, Fiber A of the first switch member 210 may be aligned with Fiber A of the second switch member 220; Fiber B of the first switch member 210 may be aligned with Fiber B of the second switch member 220; Fiber C of the first switch member 210 may be aligned with Fiber C of the second switch member 220; and so on. In a second position, achieved by rotating the first switch member 210 by four groove intervals as shown in the example depicted in FIGS. 1B and 1C, Fiber A of the first switch member 210 may be aligned with Fiber E of the second switch member 220; Fiber B of the first switch member 210 may be aligned with Fiber F of the second switch member 220; Fiber C of the first switch member 210 may be aligned with Fiber G of the second switch member 220; and so on. In this regard, the first switch member 210 may be selectively rotated in single intervals (e.g., advancing the rotational position by one groove interval) or multiple intervals (e.g., advancing the rotational position by two or more groove intervals, such as four groove intervals as in the depicted example).

With reference to FIGS. 1A and 2, the optical fiber grooves 106 of each switch member of the optical switch assembly may be configured to receive optical fibers therein. In some embodiments, the optical fiber grooves 106 may further be configured to receive additional optical components, such as lenses, as described in greater detail below.

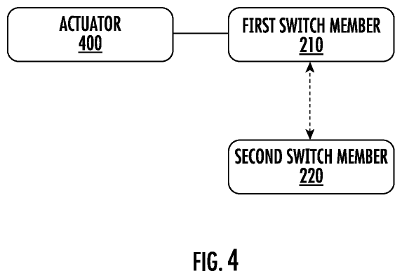

As noted above, the first switch member 210 (shown in FIG. 2) may be configured to rotate from a first position to a second position for aligning the respective optical fibers of the first and second switch members. In this regard, and with reference to FIG. 4, the optical switch assembly 200 may further comprise an actuator 400 coupled to the first switch member 210. The actuator 400 may be configured to selectively rotate the first switch member 210 about the first longitudinal axis 208 (shown in FIG. 2).

As noted above, the first switch member 210 may be configured to rotate about the first longitudinal axis 208 based at least in part on a triggering event. The triggering event may include but may not be limited to receipt of an optical, electrical, and/or mechanical signal. In some cases, the second position to which the first switch member 210 is rotated may depend on the triggering event received. For instance, the triggering event may be an electrical signal (e.g., measured electrical current or voltage) initiating rotation of the first switch member, and the characteristics of the electrical signal (e.g., the particular current or voltage) may determine or inform the rotational position into which the first switch member 210 is rotated (e.g., the second position of the first switch member). In other words, the triggering event may indicate a standard change of position (e.g., advance the position by one interval), or the triggering event may be measured and the position of the first switch member 210 may be changed based on the measured event (e.g., change the position according to the triggering event and/or information included in the triggering event).

In some embodiments, the second switch member 220 may be fixed about the second longitudinal axis 218 (e.g., the second switch member may not be able to rotate about its longitudinal axis, as in the example described above). In other embodiments, however, the second switch member 220 may be configured to selectively rotate about the second longitudinal axis 218, such that each of the first switch member and the second switch member are rotatable between a first position and a second position. Selective rotation of the first switch member 210 and the second switch member 220 may be configured to align subsets of the first and second pluralities of optical fibers 204, 214 to reach a particular input-output configuration. In such embodiments, a second actuator (not shown), which may be configured similarly to the actuator 400 (shown in FIG. 4) coupled to the first switch member 210, may be coupled to the second switch member 220 and may operate separately from or in conjunction with the actuator coupled to the first switch member 210. The actuators may selectively rotate their respective switch members simultaneously or independently to reach a desired input-output permutation. The second switch member 220 may be configured to rotate about the second longitudinal axis 218 and may selectively rotate in the same or opposite direction of the rotation of the first switch member 210.

With reference to FIG. 2, in some embodiments, the first plurality of optical fibers 204, received by the first switch member 210, may be represented by N, and the second plurality of optical fibers 214, received by the second switch member 220, may be represented by M. In an example in which the first switch member 210 is in communication with a source (e.g., an origin of signals) and the second switch member 220 is in communication with a destination (e.g., a location to which signals will be transmitted), the first plurality of optical fibers 204 may be considered inputs and the second plurality of optical fibers 214 may be considered outputs. In this example, the first switch member 210 may comprise N inputs and the second switch member 220 may comprise M outputs. The optical switch assembly 200 may thus have N inputs and M outputs, providing N×M input-output permutations. In some instances, the number of outputs M may be greater than or equal to the number of inputs N. For example, the first switch member 210 may have 4 inputs while the second switch member 220 may have 8 outputs, creating a 4×8 configuration equal to 32 input-output permutations. In other instances, the number of inputs N may be greater than or equal to the number of outputs M. In still other embodiments, N is equal to M, such as in the depicted embodiment in which N=12 and M=12.

In some embodiments, one or more of the optical fibers 204, 214 received by the first switch member 210 and the second switch member 220, respectively, of the optical switch assembly 200 may comprise lensed optical fibers. For example, the first plurality of optical fibers 204 and the second plurality of optical fibers 214 may comprise lensed optical fibers. A lens attachment to the optical fibers 204, 214 may be configured to facilitate the transmission of optical signals between the first plurality of optical fibers 204 and the second plurality of optical fibers 214. For example, at least one of the first switch member 210 or the second switch member 220 may comprise at least one lens configured to direct the optical signal between an optical fiber of the first switch member and a corresponding optical fiber of the second switch member.

In some embodiments, one or more of the optical fibers of the first plurality of optical fibers 204 and/or the second plurality of optical fibers 214 may comprise a micro-lens assembly. The micro-lens assembly may comprise a front lens mounting portion and a rear portion, wherein the rear portion is a cylindrical tube that may be bonded to the sheath and cladding of the plurality of optical fibers using an adhesive. The front lens potion may be disposed over the rear portion to adjust the desired distribution of light, as will be understood by one skilled in the art in light of this disclosure. In some cases, one or more of the lensed optical fibers may comprise a graded rod index lens (GRIN lens). The GRIN lens may comprise a first lens collimating light within the input optical fibers (e.g., a corresponding one of the first plurality of optical fibers 204) and a second lens may collect the collimated light from the first lens and focus the collimated light on the output fiber (e.g., a corresponding one of the second plurality of optical fibers 214). In some embodiments, the first subset of the first plurality of optical fibers 204 may comprise one type of lensed optical fiber (e.g., a micro-lens) and the second subset of the first plurality of optical fibers may comprise a different type (e.g., a GRIN lens). In still other cases, one or more of the lensed optical fibers may comprise a polymer lens developed directly on the fiber facet. In another example, at least one of the fibers of the first and second plurality of optical fibers 204, 214 may be cleaved to promote engagement between the aligned fibers of the first and second pluralities of optical fibers. Attachments to and modifications performed on the optical fibers as described herein may be made separately or in combination, according to the desired form and function of the optical switch assembly and performance requirements. For instance, a subset of optical fibers of a switch member may be cleaved while another subset within the same switch member may comprise a GRIN lens attachment.

In some embodiments, the optical switch assembly 200 may further comprise a latching mechanism attached to the first switch member 210 and/or the second switch member 220. The latching mechanism may align one or both switch members 210, 220 to a predefined angular position and/or may be configured to maintain the relative positions of the first and/or second switch members. In some cases, the latching mechanism may maintain the angular position of the first switch member 210 relative to the second switch member 220 such that the optical coupling of the first plurality of optical fibers 204 and the second plurality of optical fibers 214 results in an optimal signal transmission configuration between corresponding optical fiber pairs. For example, the latching mechanism may be configured to maintain the angular positions based on a strength of the signals transmitted between the optical fibers of the first switch member 210 and the corresponding optical fibers of the second switch member 220.

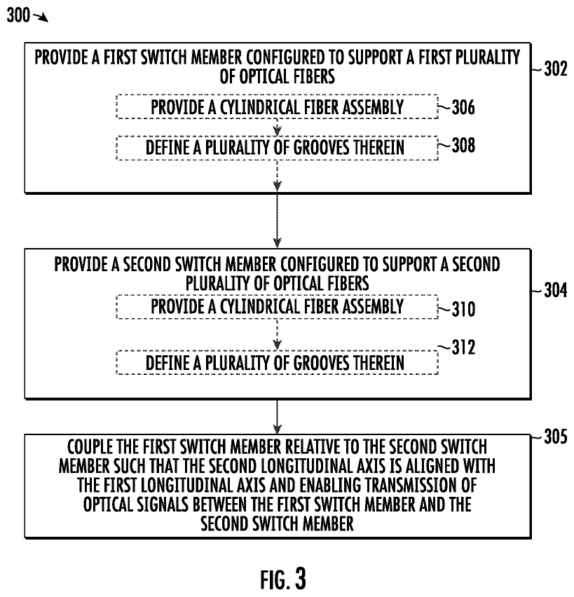

With reference to FIG. 3, a method 300 of manufacturing an optical switch assembly is shown. The method may comprise providing a first switch member configured to support a first plurality of optical fibers (Block 302). As described above in connection with FIG. 2, the first switch member may define a first longitudinal axis. The method 300 may further include providing a second switch member configured to support a second plurality of optical fibers (Block 304). The second switch member may define a second longitudinal axis. The first switch member may be coupled to the second switch member at Block 305 such that the second longitudinal axis is aligned with the first longitudinal axis and transmission of optical signals between the first switch member and the second switch member is enabled. The first switch member may be configured to selectively rotate about the first longitudinal axis. As described above, in a first position of the first switch member, a first subset of the first plurality of optical fibers is aligned with a first subset of the second plurality of optical fibers for transmitting signals therebetween. The first switch member may be configured to rotate to a second position, and in the second position of the first switch member, a second subset of the first plurality of optical fibers may be aligned with a second subset of the second plurality of optical fibers for transmitting the optical signal therebetween, as described above.

In some embodiments, providing the first switch member comprises providing a cylindrical fiber assembly (Block 306) and defining a plurality of grooves configured to receive the first plurality of optical fibers therein (Block 308). Similarly, providing the second switch member may comprise providing a cylindrical fiber assembly (Block 310) and defining a plurality of grooves configured to receive the second plurality of optical fibers therein (Block 312). In some cases, the method may further comprise coupling an actuator to the first switch member. As described above, the actuator may be configured to rotate the first switch member about the first longitudinal axis. In some embodiments, a second actuator may be coupled to the second switch member to rotate the second member about the second longitudinal axis.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods, assemblies, and systems described herein, it is understood that various other components may also be part of any optical component or optoelectronic element. In addition, the methods described above may include fewer steps in some cases, while in other cases may include additional steps. The steps and modifications to the steps of the method described above, in some cases, may be performed in any order and in any combination.

Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

That which is claimed:

1. An optical switch assembly comprising:
a first switch member configured to support a first plurality of optical fibers, wherein the first switch member defines a first longitudinal axis; and
a second switch member configured to support a second plurality of optical fibers, wherein the second switch member defines a second longitudinal axis, and wherein the second longitudinal axis is aligned with the first longitudinal axis;
wherein the first switch member is configured to selectively rotate about the first longitudinal axis,
wherein, in a first position of the first switch member, a first subset of the first plurality of optical fibers is aligned with a first subset of the second plurality of optical fibers for transmitting optical signals therebetween, and
wherein the first switch member is configured to rotate to a second position, wherein, in the second position of the first switch member, a second subset of the first plurality of optical fibers is aligned with a second subset of the second plurality of optical fibers for transmitting optical signals therebetween.

2. The optical switch assembly of claim 1, wherein the first subset of the first plurality of optical fibers is the same as the second subset of the first plurality of optical fibers.

3. The optical switch assembly of claim 1, wherein the first subset of the second plurality of optical fibers is the same as the second subset of the second plurality of optical fibers.

4. The optical switch assembly of claim 1, wherein each of the first switch member and the second switch member comprises a cylindrical fiber assembly defining a plurality of grooves configured to receive optical fibers therein.

5. The optical switch assembly of claim 1, wherein the second switch member is fixed about the second longitudinal axis.

6. The optical switch assembly of claim 1, wherein the first switch member comprises N inputs and the second switch member comprises M outputs, wherein the optical switch assembly is configured to provide N×M input-output permutations.

7. The optical switch assembly of claim 6, wherein N is equal to M.

8. The optical switch assembly of claim 1, wherein the optical switch assembly further comprises an actuator coupled to the first switch member, wherein the actuator is configured to selectively rotate the first switch member about the first longitudinal axis.

9. The optical switch assembly of claim 1, wherein the first switch member is configured to rotate about the first longitudinal axis based at least in part on a triggering event.

10. The optical switch assembly of claim 1, wherein the first plurality of optical fibers and the second plurality of optical fibers comprise lensed optical fibers.

11. The optical switch assembly of claim 1, wherein at least one of the first switch member or the second switch member comprises at least one lens configured to direct the optical signal between an optical fiber of the first switch member and a corresponding optical fiber of the second switch member.

12. The optical switch assembly of claim 1, wherein the second switch member is configured to selectively rotate about the second longitudinal axis.

13. A method of manufacturing an optical switch assembly, the method comprising:
providing a first switch member configured to support a first plurality of optical fibers, wherein the first switch member defines a first longitudinal axis;
providing a second switch member configured to support a second plurality of optical fibers, wherein the second switch member defines a second longitudinal axis; and
coupling the first switch member relative to the second switch member such that the second longitudinal axis is aligned with the first longitudinal axis and transmission of optical signals between the first switch member and the second switch member is enabled,
wherein the first switch member is configured to selectively rotate about the first longitudinal axis,
wherein, in a first position of the first switch member, a first subset of the first plurality of optical fibers is aligned with a first subset of the second plurality of optical fibers for transmitting optical signals therebetween, and
wherein the first switch member is configured to rotate to a second position, wherein, in the second position of the first switch member, a second subset of the first plurality of optical fibers is aligned with a second subset of the second plurality of optical fibers for transmitting the optical signal therebetween.

14. The method of claim 13, wherein providing each of the first switch member and the second switch member comprises providing a cylindrical fiber assembly and defining a plurality of grooves configured to receive the first and second optical fibers respectively therein.

15. The method of claim 13, wherein the second switch member is fixed about the second longitudinal axis.

16. The method of claim 13, wherein the first switch member comprises N inputs and the second switch member comprises M outputs, wherein the optical switch assembly is configured to provide N×M input-output permutations.

17. The method of claim 13, wherein the first plurality of optical fibers and the second plurality of optical fibers comprise lensed optical fibers.

18. The method of claim 13, wherein at least one of the first switch member or the second switch member comprises at least one lens configured to direct optical signals between an optical fiber of the first switch member and a corresponding optical fiber of the second switch member.

19. The method of claim 13 further comprising coupling an actuator to the first switch member, wherein the actuator is configured to rotate the first switch member about the first longitudinal axis.

20. The method of claim 13, wherein the first switch member is configured to rotate about the first longitudinal axis based at least in part on a triggering event.
